(19) United States
(12) Patent Application Publication
(10) Pub. No.: US 2007/0159013 A1
(43) Pub. Date: Jul. 12, 2007

(54) Motor drive device

(76) Inventors: Takahiro Maruyama, Ueda-shi (JP); Yoshikazu Ito, Sakura-shi (JP)

Correspondence Address: BIRCH STEWART KOLASCH & BIRCH, PO BOX 747, FALLS CHURCH, VA, 22040-0747, US

(21) Appl. No.: 10/588,701

(22) PCT Filed: Feb. 4, 2005
(86) PCT No.: PCT/JP05/01668

§ 371 Date: Aug. 8, 2006

(30) Foreign Application Priority Data
Feb. 9, 2004 (JP) 2004-032295
Feb. 9, 2004 (JP) 2004-032300
Feb. 9, 2004 (JP) 2004-032285

(51) Int. Cl. H02K 5/24; H02K 7/10; H02K 5/10

(52) U.S. Cl. 310/51; 310/88; 310/83

(57) ABSTRACT

A motor is inserted in the axial direction from an opening section into a motor case, one end surface in the axial direction of a stator is butted against an inner wall surface of the case, and the stator is urged toward axially one end surface side from axially the other end surface side and fixed in the motor case.

### FIELD OF TECHNOLOGY

The present invention relates to a motor drive device, which is used for, for example, opening and closing a vehicle sun roof.

### BACKGROUND TECHNOLOGY

Motor drive devices, which drives electric motors of actuators, are used in, for example, home electric appliances, e.g., refrigerator, fan; office automation equipments, e.g., copy machine, printer; automobile-related appliances, e.g., sun roof drive device, window open-close device, door open-close device, shift controller for switching driving state of engine.

Electric motors, e.g., inner or outer rotor type DC brush motor, DC brushless motor, stepping motor, are used as power sources of such motor drive devices, and they are controlled by drive circuits (motor drive circuits) including CPUs or MPUs. Typically, each of the motors is accommodated in a motor case and fixed on a mounting surface of the motor case by screws, or a stators of the motor is mounted on the mounting surface together with a control board and fixed thereon by screws pierced through the stator.

In a motor drive device using a geared motor, a control board is accommodated in a housing-shaped board case so as to protect electric parts, so that the control board is located near the motor and a gear case but separately accommodated from them (see Japanese Patent Gazette No. 2003-189546).

For example, in the motor drive device for driving a shift controller or a sun roof, rotation of a motor shaft is transmitted via a transmission mechanism including reduction gears so as to actuate a cable, a rack or a gear pulley. In the shift controller, a board case accommodating a control board and a gear case accommodating gears for transmitting rotation of the motor are respectively provided in separated spaces, which are partitioned by a partition wall (see Japanese Patent Gazette No. 2003-189546); in the sun roof drive device, a control board is not located immediately under reduction gears, so their positions are mutually shifted (see Japanese Patent Gazette No. 2001-30763).

Lubricant, e.g., grease, is usually applied to the transmission mechanisms including the reduction gears so as to prevent abrasion of gears and improve rotational property of shafts, but short circuits and troubles occurred by dropping lubricant onto the control boards can be prevented by the above described structures, further an interference between the electric parts and the gears can be prevented.

When each of the motor drive devices is assembled, the stator and an end bracket must be fixed to the motor case by, for example, screws, so steps of assembling the motor drive device must be increased and production efficiency must be lowered. Especially, in a small motor drive device, a flange for fixing a motor with screws is required, so number of parts must be increased and the device cannot be downsized.

In the geared motor, sliding noise of a brush, vibration noise caused by cogging and torque ripple and mechanical vibrations, e.g., rotational vibrations of the motor, will be transmitted from the motor case to the board case and amplified, so the noise will be increased. If the housing or the board case is made thick so as to prevent the increase of the noise, the drive device must be large and a production cost must be increased.

In the sun roof drive device installed in a small space of a fixed roof, the device must be small in size, noise of the device must be reduced as much as possible because the device is actuated immediately above heads of a driver and passengers, and vibrations must be restrained due to stably open and close the roof.

In case of separately accommodating the control board and the transmission mechanism, the partition must be provided in the board case, so a height of the case must be higher and the motor drive device must be large in size. In case of shifting the control board from the transmission mechanism, an install area of the device must be increased.

Especially, the sun roof drive device must be installed in the small space of the fixed roof, so a height and an install area of the device must be reduced as much as possible.

### DISCLOSURE OF THE INVENTION

A first object of the present invention is to provide a motor drive device, in which number of parts for attaching a motor in a small space can be reduced so as to downsize the device and efficiently attach the motor.

A second object is to provide a motor drive device, in which a board case accommodating a control board is made thin and downsized so as to install in the small space and is capable of reducing noise amplified by the case.

A third object is to provide a motor drive device, which is capable of reducing a height and an install area so as to install the device in the small space.

To achieve the object, the motor drive device of the present invention has following structures.

A first basic structure of the motor drive device comprises: a stator core enclosing a space and being constituted by coils, which are respectively wound on stator teeth; and a motor shaft being provided in the space, equipped with a rotor magnet and rotatably held by a motor case, and one end surface in the axial direction of the stator is butted against an inner wall surface of the motor case, and the stator is urged toward axially one end surface side from axially the other end surface side and fixed in the motor case by fitting a lid in an opening section of the motor case.

In the motor drive device, an elastic member may be sandwiched between the other end surface in the axial direction of the stator and the lid.

In the motor drive device, the lid may be snap-fitted in the opening section of the motor case.

In the motor drive device, a brushless motor may be attached to the motor case.

A second basic structure of the motor drive device comprises: a motor; and a control board including a motor drive circuit, and a board case, which accommodates the control board, and dampers are integrated with a motor case.

In the motor drive device, the control board may be attached to the board case by: piling the control board on a board receiving section in the board case; and clamping the control board and the board receiving section, which have been piled, between the dampers.

In the motor drive device, an opening section may be formed from an outer mounting surface to a side surface of the board case, which is formed like a housing; the board receiving section, which forms a cavity on the outer mounting surface side in the opening section, may be inwardly projected in the board case; the dampers may be inserted through the opening section on the side surface side so as to clamp the control board and the board receiving section, which have been piled; and screws may be inserted into axial holes of the dampers so as to fix to the motor case.

In the motor drive device, the motor drive device may be used for opening and closing a vehicle sun roof.

A third basic structure of the motor drive device comprises: a motor; a speed reduction unit, which is linked with a motor shaft and which transmits driving torque, and a control board, which includes a motor drive circuit, being faced and attached in a board case; and a shielding member being provided between the speed reduction unit and the control board so as to separate the two in one space of the board case, the shielding member having a shaft hole, through which an output shaft of the speed reduction unit is pierced.

In the motor drive device, the speed reduction unit and the shielding member, which covers the speed reduction unit, may be attached to a first case; and the first case, to which the control board is attached, may be integrated with a second case, whereby the speed reduction unit and the control board are separated in one space.

In the motor drive device, the shielding member may be a laminated sheet-shaped member, in which a flat cloth sheet is provided on the speed reduction unit side and a plastic sheet is provided on the control board side.

In the motor drive device, the motor drive device may be used for opening and closing a vehicle sun roof.

In the motor drive device of the first basic structure, the one end surface in the axial direction of the stator is butted against the inner wall surface of the motor case, and the stator is urged toward axially one end surface side from axially the other end surface side and fixed in the motor case, so that a step of fixing the stator with screws can be omitted, the device can be efficiently assembled, number of parts can be reduced and the device can be downsized.

The motor is not tightly fixed to the motor case by adhesive or thermocompression bonding, so that the motor case can be positioned and fixed without deformation, which is caused by differences of thermal expansion coefficients between the motor case and parts of the motor; no deformation and no break are occurred in the motor case even if the device is used in harsh environments.

By sandwiching the elastic member between the other end surface in the axial direction of the stator and the lid, the stator can be positioned in the motor case by the elastic force of the elastic member, and rotational vibrations of the motor can be absorbed by the elastic member so that noises can be reduced.

By easily snap-fitting the lid in the opening section of the motor case, the motor can be easily attached by inserting the motor into the case in the axial direction and fitting the lid in the opening section, so that the device can be efficiently assembled.

By accommodating the brushless motor in the motor case, noises can be further reduced.

In the motor drive device of the second basic structure, the board case, which accommodates the control board, and the dampers are integrated with the motor case, so that mechanical vibrations generated on the motor case side can be absorbed by the dampers and transmission of the vibrations to the board case can be prevented. Therefore, noises can be reduced in spite of the small and thin board case.

By attaching the control board to the board case by: piling the control board on the board receiving section in the board case; and clamping the control board and the board receiving section, which have been piled, between the dampers, inherent brush noise of the motor, vibration noise caused by cogging and torque ripple and rotational vibrations of the motor can be absorbed by the dampers, so that transmission of the noises can be restrained and vibration noise of the case can be reduced.

By forming the opening section from the outer mounting surface to the side surface of the board case, which is formed like the housing and inwardly projecting the board receiving section, which forms the cavity on the outer mounting surface side in the opening section, in the board case, the dampers can be inserted through the opening section on the side surface side so as to clamp the control board and the board receiving section, which have been piled, and the screws can be inserted into the axial holes of the dampers so as to fix to the motor case, so that number of parts can be reduced and the device can be efficiently assembled.

Further, by using the motor drive device for opening and closing the vehicle sun roof, downsizing the board case is accelerated, the device can be installed in a small space of a fixed roof of the vehicle and noises can be reduced.

In the motor drive device of the third basic structure, the control board, which includes the motor drive circuit, is faced and attached in the board case, and the shielding member is provided between the speed reduction unit and the control board so as to separate the two in one space of the board case, so that the speed reduction unit and the control board can be overlapped at the lowest position, at which no assembling defect of the two occurs, a height and an install area of the device can be greatly reduced and the device can be downsized.

Further, the speed reduction unit and the control board, which are mutually faced in one space, are separated by the shielding member, no lubricant, e.g., grease, drops onto the control board from the speed reduction unit, so the control board can be freely designed.

By attaching the speed reduction unit and the shielding member, which covers the speed reduction unit, to the first case and integrating the first case, to which the control board is attached, with the second case, the speed reduction unit and the control board are separated in one space so that the device can be efficiently assembled.

By using the laminated sheet-shaped member, in which the flat cloth sheet is provided on the speed reduction unit side and the insulating plastic sheet is provided on the control board side, as the shielding member, lubricant can be absorbed by the cloth sheet even if the lubricant is scattered, further electric insulation to the drive circuit can be securely maintained even if electric parts contact the shielding member which is the insulating sheet.

By using the motor drive device for opening and closing the vehicle sun roof, the small motor drive device can be installed in a small space of a fixed roof of the vehicle.

### BRIEF DESCRIPTION OF THE DRAWINGS

FIG. 1 is a block diagram of a sun roof drive device.

FIGS. 2A and 2B are a plan view of the sun roof drive device seen from a board case side and a front view thereof.

FIGS. 3A-3C are a partial cutaway view seen from a motor case side, a partial sectional view taken along a line A-A and a sectional view taken along a line B-B.

FIG. 4 is an explanation view of a 3-phase DC brushless motor.

FIGS. 5A and 5B are an explanation view of the motor case accommodating a reduction gear and a shielding member.

FIG. 6 is a partial sectional view of an assembly structure of the motor case and a lid.

### PREFERRED EMBODIMENTS OF THE INVENTION

Preferred embodiments of the motor drive device of the present invention will be explained with reference to the accompanying drawings. The motor drive devices of the embodiments can be widely applied to appliances driven by electric motors. In the present embodiment, the motor drive device is used as a sun roof drive device for opening and closing a vehicle sun roof. The sun roof drive device slides a slide panel, which is connected to a geared cable (a cable having a spiral gear groove) engaged with an output gear rotated by a motor and a push-pull means, e.g., plastic belt, between a full-open position and a full-close position and tilts a rear end of the slide panel, so that an opening of a fixed roof is opened and closed.

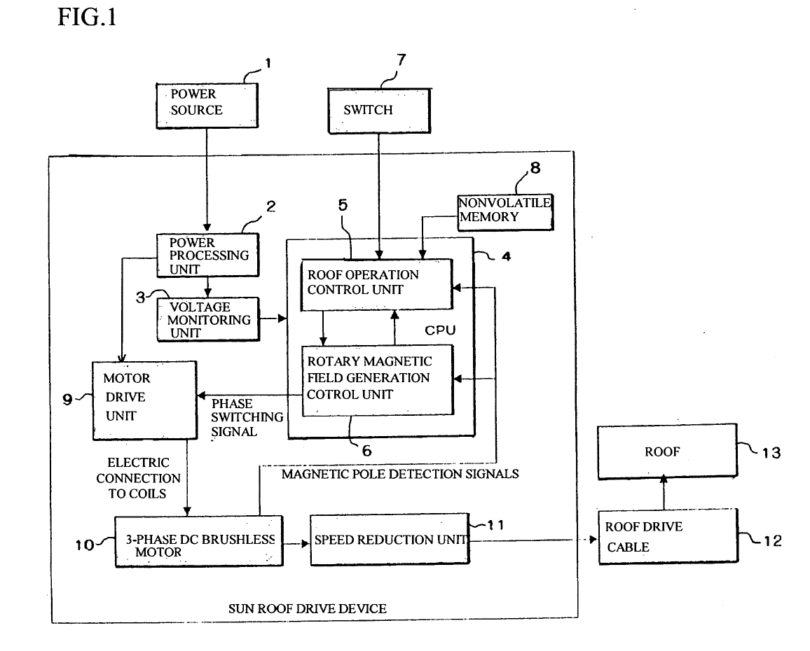

An outline of the sun roof drive device for driving a vehicle sun roof will be explained with reference to a block diagram of FIG. 1. An electric power source 1 is a battery or a fuel cell provided in a vehicle, and source voltage (e.g., battery voltage of 12V) is applied to a power processing unit 2. The power processing unit 2 converts the source voltage (e.g., 12V) into control voltage (e.g., 5V), stabilizes the source voltage, protects against reverse connection and turns on and off the power source on the basis of external signals. A voltage monitoring unit 3 monitors the control voltage applied to a CPU (central processing unit) 4 and sends an input signal to the CPU 4 when voltage drop occurs.

The CPU 4 controls the sun roof drive device, namely it controls the action of the vehicle sun roof and phase switching so as to generate rotary magnetic fields of the motor. In the CPU 4, a roof operation control unit 5, which controls opening and closing actions of the roof 13, and a rotary magnetic field generation control unit 6, which generates rotary magnetic fields on the basis of magnetic pole detection signals sent from the motor so as to control rotation of the motor, are formed in one chip. A start signal is inputted to the CPU 4 from, for example, a switch 7 of an operation panel, then the roof operation control unit 5 actuates the rotary magnetic field generation control unit 6 so as to start the motor.

Control data, e.g., present roof position, predetermined open position and close position, speed reducing positions, rotational numbers of the motor, are written in a nonvolatile memory (e.g., EEPROM) 8, and the data can be rewritten according to need. For example, a previous position of the roof is read when the power source 1 is turned on; a new position of the roof is written in the nonvolatile memory 8 when the voltage monitoring unit 3 detects voltage drop of the source voltage. A motor drive unit 9 sends phase switching signals (drive voltage) to the 3-phase DC brushless motor 10, which acts as the drive source, via a drive circuit (3-phase bridge circuit) including switching elements, e.g., transistors, IGBTs, FETs. An electric power is supplied from a power processing unit 2 to the motor drive unit 9. The DC brushless motor 10 pushes and pulls a roof drive cable 12 by a speed reduction unit 10 to be described. Therefore, a roof (slide panel) 13, which is linked with the roof drive cable 12, can be moved to open and close the opening of the fixed roof.

3-phase detection pulse signals are respectively sent from magnetic sensors or magnetic/electric converting elements (e.g., hall elements, hall ICs, MR elements), which are provided to the DC brushless motor 10, to the roof operation control unit 5 and the rotary magnetic field generation control unit 6. The roof operation control unit 5 monitors a roof speed (rotation number of the motor) and number of pulses of the phase switching signals on the basis of control programs and sends a command to the rotary magnetic field generation control unit 6 so as to renew the phase switching signals when the roof speed (rotation number of the motor) is too fast or too slow. Further, the roof operation control unit 5 generates roof position data on the basis of the 3-phase detection pulse signals.

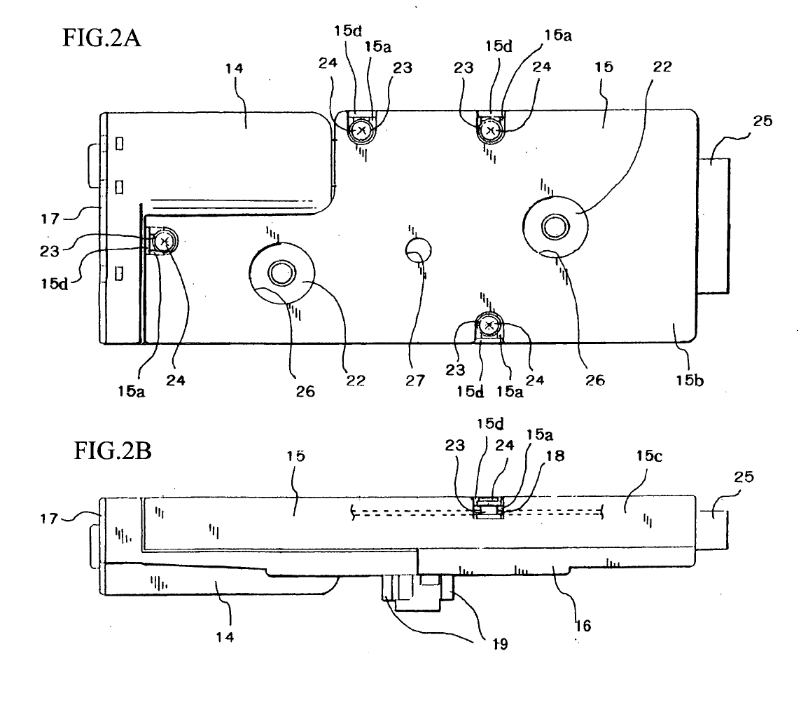

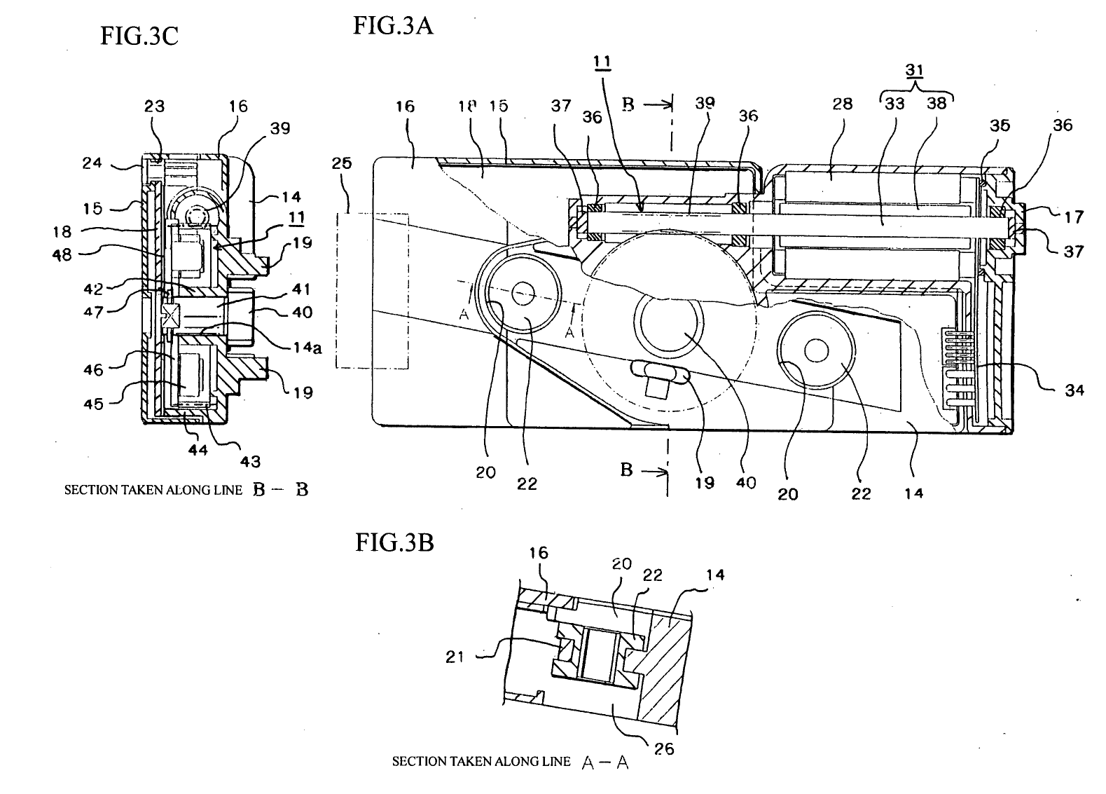

Next, a concrete structure of the sun roof drive device will be explained with reference to FIGS. 2 and 3. In FIGS. 2A and 2B, the sun roof drive device is constituted by a board case 15, a motor case 14 covering the board case 15 and an exterior case 16. The motor case 14 accommodates the 3-phase DC brushless motor 10 and a cable drive mechanism, which is linked with the DC brushless motor 10 by the speed reduction unit 11 so as to push and pull the roof drive cable 12 (see FIG. 1). A control board 18, on which the electronic parts, e.g., the CPU 14, the motor drive unit 9, the nonvolatile memory 8 (see FIG. 1), constituting a control circuit, are mounted, is attached to the board case 15. The exterior case 16 covers the control board 18 attached to the board case 15.

The 3-phase DC brushless motor 10 is inserted in the motor case 14 and fixed in the case by fitting a lid 17. A pair of guide plates 19, which guide a movement of the roof drive cable 12, are outwardly projected from an outer surface of the motor case 14 (see FIG. 2B). In FIG. 3A, two through-holes 20 are formed in the motor case 14 along a moving route of the roof drive cable 12. In FIG. 3B, a C-shaped holder 21, which is provided to an inner face of each through-hole 20, fits in an outer face (circumferential groove) of a damper (e.g., grommet, rubber pad) 22. The dampers 22 are provided so as not to transmit rotational vibrations of the DC brushless motor 10 to a roof drive unit supporting section and the roof drive cable 12 (see FIG. 1) via the motor case 14.

In FIGS. 2A and 2B, the control board 18 is piled on a board receiving section 15a in the board case 15, and an upper surface and a lower surface of the control board 18 and the board receiving section 15a, which have been piled, are clamped between dampers (grommets) 23, so that the control board 18 is fixed to the board case 15. In the present embodiment, an opening section 15d is formed from an outer mounting surface 15b of the housing-shaped board case 15 to a side surface 15c thereof. The board receiving section 15a (a planar shape is a U-shape, see FIG. 2A), which forms a cavity on the outer mounting surface side in the opening section 15d, is inwardly projected in the board case 15. The dampers 23 are inserted through the opening section 15d on the side surface 15c side so as to clamp the control board 18 and the board receiving section 15a, which have been piled, and screws 24 are inserted into center holes of the dampers 23 so as to fix to the motor case (other cases) 14. Preferably, each of the dampers (grommets) 23 is a cylindrical rubber member having a circular groove formed in an outer circumferential face, and a collar (a metallic cylinder) is fitted in an axial hole.

Since end faces of the control board 18 and the board receiving section 15a are butted against the dampers 23 and the upper surface and the lower surface are clamped so as to fix the control board 18 to the board case 15, rotational vibrations of the operating motor are absorbed by the dampers 23; transmitting the vibrations to the control board 18 and the board case 15 can be restrained, and vibration noise of the case can be reduced even if the board case 15 is small and thin. Especially, in a motor having a small-diameter rotor, the rotor is rotated at high speed so rotational vibrations are apt to be transmitted to the board case 15; in a geared motor having a long motor shaft, vibrations are apt to be transmitted; therefore, it is very effective for the motor drive device to use dampers 23.

A connector 25 is connected to the control board 18 and outwardly projected from an opening section of the board case 15. A terminal connector (not shown) of a vehicle will be electrically connected to the connector 25 when the sun roof drive device is attached in the fixed roof of the vehicle.

In FIG. 2A, through-holes 26, which correspond to the dampers 22 and an output shaft to be described, are formed in the board case 15 and the control board 18. When the sun roof drive unit is attached, screw holes (not shown) of the roof drive cable 12 are corresponded to the through-holes 20 (see FIG. 3B) of the motor case 14. Namely, a washer (not shown) is set on each damper 22 from the board case 15 side, then a screw is inserted into the center hole of each damper 22 and screwed with the screw hole, so that the sun roof drive device can be fixed and linked with the roof drive cable 12. In FIG. 2A, a through-hole 27 for inserting a tool is formed in the board case 15. When the sun roof drive device emergency-stops, the tool is inserted into the through-hole 27 so as to engage the tool with the output shaft 41 and rotate an output gear, so that the roof drive cable 12 can be moved and the roof 13 (see FIG. 1) can be manually opened and closed.

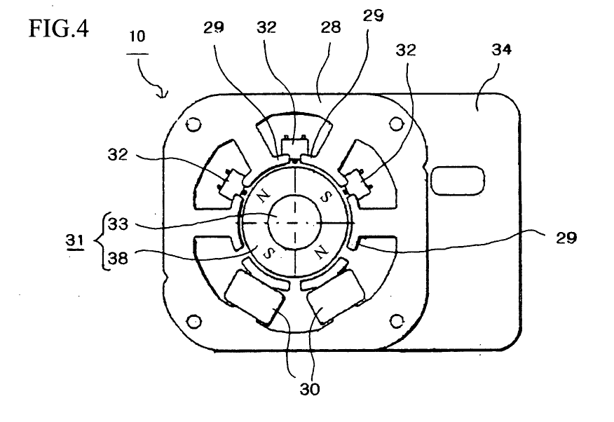

Next, the DC brushless motor 10 will be explained with reference to FIGS. 3 and 4. In FIG. 4, the DC brushless motor 10 is, for example, a 4-pole/6-slot inner rotor type 3-phase DC brushless motor. A stator core 28 is, for example, a layered core having six stator teeth 29, which are radially inwardly extended. Stator coils 30 are respectively wound on the stator teeth 29. A rotor 31 is provided in a space enclosed by the stator core 28. By employing the inner rotor type motor whose rotor diameter is small, inertia and rotational vibrations of the rotor can be restrained, so that noises can be reduced and processing the rotor 31 for achieving a rotational balance can be omitted. Three magnetic sensors or magnetic/electric converting elements (e.g., hall elements, hall ICs, MR elements) 32 provided at the periphery of an outer edge of the rotor, and they face the rotor. Note that, the DC brushless motor 10 is not limited to the 4-pole/6-slot motor, but the above described example is suitable in view of torque reduction caused by multiple poles.

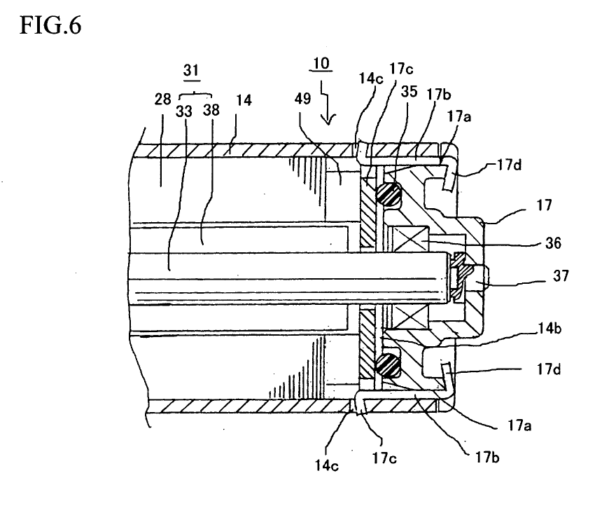

In FIG. 3A, the magnetic sensors 32 are provided to a sensor board 34, which is arranged perpendicular to a motor shaft 33. The sensor board 34 is butted against the end surface of the stator core 28 with a filler piece (e.g., an insulator 49 shown in FIG. 6), and an elastic member 35, e.g., O-ring, is sandwiched between the sensor board 34 and the lid 17, so that it is fixed in the motor case 14. The sensor board 34 is electrically connected to the control circuit of the control board 18 by cables.

In FIG. 3A, the motor shaft 33 equipped with the rotor 31 is supported by three radial bearings 36, which are provided in the motor case 14 and the lid 17. Both ends of the motor shaft 33 respectively contact thrust holders 37, which are respectively provided in the motor case 14 and the lid 17. The rotor 31 is a cylindrical rotor magnet 38, which is fitted to an outer face of the motor shaft 33. In the rotor magnet 38, N-magnetic poles and S-magnetic poles are alternately formed in a circumferential direction. The rotor magnet 38 may be skew-magnetized or sinusoidal-magnetized in radial directions; in this case, torque clip and cogging of the motor are reduced, so that rotational vibrations can be reduced.

Next, the speed reduction unit 11 will explained. In FIG. 3A, the motor shaft 33 of the DC brushless motor 10 is pierced through the stator core 28, one end is radially supported by the bearing 36 in the motor case 14, and the other end is radially supported by the bearing 36 in the lid 17. A worm section 39, in which a gear groove is spirally formed, is formed in a part of the motor shaft 33 extended on the one end side.

In FIG. 3C, the output shaft 41, which is integrated with the output gear (pinion gear) 40, is fitted into a shaft hole 14a of the motor case 14 from the outer side. A cylindrical boss 42 is inwardly extended from an edge of the shaft hole 14a of the motor case 14, and a shaft hole of a reduction gear (worm gear) 43 is fitted in the boss 42. The reduction gear 43 is assembled in the motor case 14, its inner circumferential face faces the boss 42, its outer circumferential face is enclosed by a gear accommodating wall 44 of the motor case 14, and the reduction gear engages with the worm section 39 of the motor shaft 33 at a specific position, at which the both perpendicularly engage.

A plurality of dampers 45, which are inserted in an inner part of the reduction gear 43, are integrated with a lock plate 46. The reduction gear 43 is fitted with the boss 42, the output shaft 41 is fitted in the shaft hole 14a, and a C-ring 47 is attached to one end of the output shaft, which is extended from a side face of the reduction gear 43 so that the both are integrated.

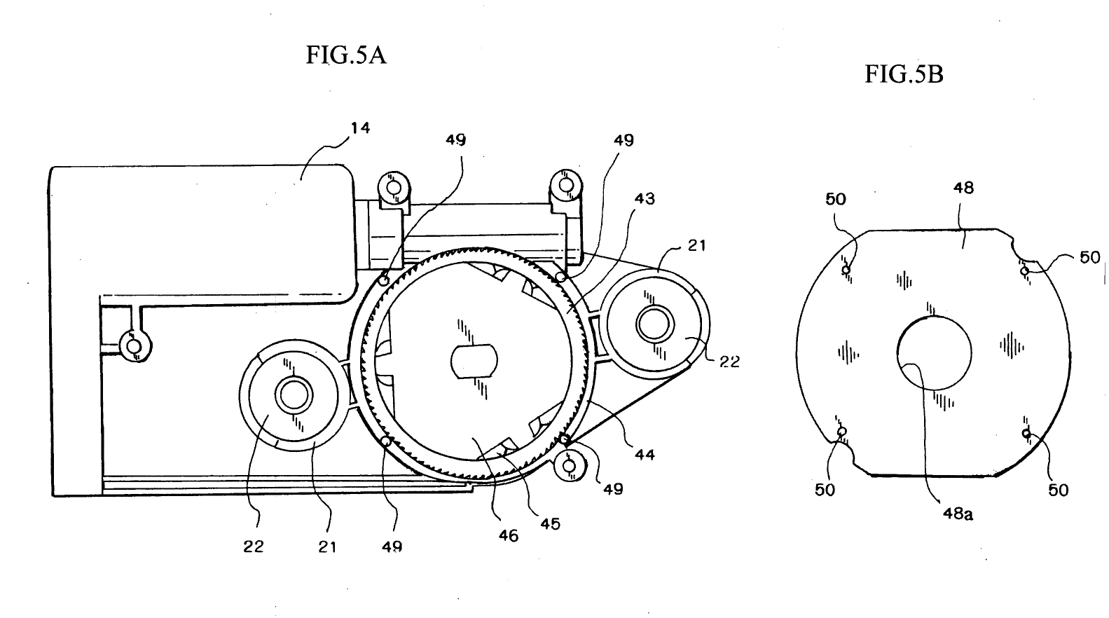

In FIG. 3A, the speed reduction unit 11 and the control board 18 are assembled in the case and mutually faced. In FIG. 3C, a shielding member 48 (see FIG. 5B) is provided between the speed reduction unit 11 and the control board 18, which are provided in the case, so as to separate the two members in one space, and the shielding member has a shaft hole 48a, through which the output shaft 41 of a reduction gear 43 is pierced. Concretely, the reduction gear 43 is rotatably attached in the motor case 14 (first case) (see FIG. 5A), and the shielding member 48 (see FIG. 5B) covering the reduction gear 43 is further attached.

In FIG. 5A, four projections 49 are formed in an end surface of a gear accommodating wall 44, which is extended from an inner face of the motor case 14. The projections 49 are respectively fitted in four fitting holes 50 of the shielding member 48 shown in FIG. 5B, so that the shielding member 48 is butted against an end surface of the gear accommodating wall 44 and attached to cover the reduction gear 43. On the other hand, the control board 28 is fixed in the board case (second case) 15 (see FIG. 2B). By assembling the motor case 14 and the board case 15, the control board 18 and the reduction gear 43 are separated by the shielding member 48 in one space (see FIG. 3C).

Preferably, the shielding member 48 is a laminated sheet-shaped member, in which a cloth sheet, e.g., velvet, velour, is provided on the reduction gear 43 side and a plastic sheet is provided on the control board 18 side. With this structure, lubricant scattered or dropped can be absorbed by the cloth sheet, and electric insulation to the drive circuit can be securely maintained even if electric parts contact the shielding member 48 which is the insulating sheet.

As described above, the reduction gear 43 and the control board 18, on which electric parts are mounted, are provided in one space of the case and separated by the shielding member 48, and the reduction gear 43 and the control board 18 can be overlapped at the lowest position, at which no assembling defect of the two occurs, and accommodated in the case, so that a height and an install area of the motor drive device can be greatly reduced and downsized. Further, the speed reduction unit 43 and the control board 18 are separated by the shielding member 48, no lubricant, e.g., grease, drops onto the control board from the reduction gear 43, so the control board 18 can be freely designed. Note that, the shielding member 48 is not limited to the laminated sheet-shaped member, so a unilaminar sheet may be employed.

Next, an assembly structure of the DC brushless motor 10 and the motor case 14 will be explained with reference to FIGS. 3A and 6. In FIG. 6, an opening section 14b is formed in the end part of the housing-shaped motor case 14. The lid (end bracket) 17, in which the bearing 36 and the thrust holder 37 are fitted, is attached to the opening section 14b. Engages holes 14c are formed in the vicinity of the opening section of the motor case 14. Metallic clips 17b are attached on the both sides of an outer circumferential face 17a of the lid 17. In each of the clips 17b, hooks 17c and 17d are formed at ends by bending the ends. The hook 17d contacts the outer circumferential face 17a, but the hook 17c is separated therefrom. When the lid 17 is attached to the opening section 14b, the clips 17b are elastically deformed at positions 17e in the outer circumferential face 17a, which act as fulcrum points, so the hooks 17c are once inwardly moved in the opening section, and parts of the clips on the hook 17d side press the motor case 14, then the lid is pressed into the case in this state. With this action, the hooks 17c of the clips 17b are radially outwardly moved, by elasticity, in the engage holes 14c and respectively engaged therewith, so that the lid can be snap-fitted and fixed. By employing the metallic clips 17b, strain caused by elastic deformation of the motor case 14, which occurs on the hook 17d side when the lid 17 is attached, can be reduced by swing motions of the hooks 17c on the fulcrum points 17e, and the hooks can be tightly engaged with the engage holes 14c. Since the lid 17 can be easily fixed to the motor case 14 by the snap-fit action, they can be highly efficiently fixed.

In FIG. 3A, the one end surface in the axial direction (on the left side in the drawing) of the stator core 28 is butted against the inner wall surface 14d of the case; by fitting the lid 17 in the opening section 14b, the other end surface (on the right side in the drawing) of the stator core 28 is urged toward axially one end surface side from axially the other end surface side, so that the stator is fixed in the motor case 14. Concretely, as shown in FIG. 6, the sensor board 34 is fixed to a part of the stator core 28, which is located on axially the other end surface side, with the insulator 49. An elastic member (e.g., O-ring) 35 is provided on the sensor board 34, and the elastic member 35 is clamped between the lid 17 and the sensor board 34.

Since the elastic member 35 is sandwiched between the stator core 28 and the lid 17, the DC brushless motor 10 can be correctly positioned in the motor case 14 by elasticity of the elastic member 35, and rotational vibrations of the motor can be absorbed by the elastic member 35, so that operation noise can be reduced.

In FIG. 3A, the motor shaft 33 having the worm section 39 is firstly inserted into the motor case 14 from the opening section 14 so as to accommodate the DC brushless motor 10 therein. In the state that the one end surface in the axial direction (on the left side in the drawing) of the stator core 28 is butted against the inner wall surface 14d of the case, the elastic member 35 is mounted onto the sensor board 34, then the lid 17 is snap-fitted in the opening section 14a, so that the elastic member 35 is clamped between the stator and the lid 17 and the DC brushless motor 10 is fixed to the motor case 14.

Since the stator is urged toward axially one end surface side, by the elastic member 35, and fixed in the motor case 14, a step of fixing the stator with screws can be omitted, so the device can be efficiently assembled. The DC brushless motor is not tightly fixed to the motor case (plastic case) 14 by adhesive or thermocompression bonding, so that the plastic case can be positioned and fixed without deformation, which is caused by differences of thermal expansion coefficients between the plastic case and parts of the motor; no deformation and no break are occurred in the plastic case even if the device is used in harsh environments.

When the DC brushless motor starts, the motor shaft 33 is rotated in a prescribed direction, a rotational speed is reduced by the reduction gear 43 engaged with the worm section 39, and the output shaft 41 and the output gear 40 are rotated (see FIG. 3A). Therefore, the roof drive cable 12 engaged with the output gear 40 is moved (the push-pull action) so as to open and close the roof 13 (see FIG. 1).

In the above described embodiment, the motor drive device is applied to the sun roof drive device, but the present invention may be applied to, for example, a sunshade drive device which opens and closed a sunshade, and many types of motor drive devices, which actuate electric home appliances, office automation appliances, automotive equipments, etc. Further, the motor drive device of the present invention is capable of driving many types of motors, e.g., DC brush motor, DC brushless motor, stepping motor.

1. A motor drive device comprising: a stator core enclosing a space and being constituted by coils, which are respectively wound on stator teeth; and a motor shaft being provided in the space, equipped with a rotor magnet and rotatably held by a motor case,
wherein one end surface in the axial direction of said stator is butted against an inner wall surface of said motor case, and said stator is urged toward axially one end surface side from axially the other end surface side and fixed in said motor case by fitting a lid in an opening section of said motor case.

2. The motor drive device according to claim 1,
wherein an elastic member is sandwiched between the other end surface in the axial direction of said stator and said lid.

3. The motor drive device according to claim 1,
wherein said lid is snap-fitted in the opening section of said motor case.

4. The motor drive device according to claim 1,
wherein a brushless motor is attached to said motor case.

5. A motor drive device comprising: a motor; and a control board including a motor drive circuit,
wherein a board case, which accommodates said control board, and dampers are integrated with a motor case.

6. The motor drive device according to claim 5,
wherein said control board is attached to said board case by: piling said control board on a board receiving section in said board case; and clamping said control board and said board receiving section, which have been piled, between the dampers.

7. The motor drive device according to claim 5,
wherein an opening section is formed from an outer mounting surface to a side surface of said board case, which is formed like a housing; said board receiving section, which forms a cavity on the outer mounting surface side in the opening section, is inwardly projected in said board case; the dampers are inserted through the opening section on the side surface side so as to clamp said control board and said board receiving section, which have been piled; and screws are inserted into axial holes of the dampers so as to fix to said motor case.

8. The motor drive device according to claim 5,
wherein said motor drive device is used for opening and closing a vehicle sun roof.

9. A motor drive device comprising: a motor; a speed reduction unit, which is linked with a motor shaft and which transmits driving torque, and a control board, which includes a motor drive circuit, being faced and attached in a board case; and a shielding member being provided between said speed reduction unit and said control board so as to separate the two in one space of said board case, said shielding member having a shaft hole, through which an output shaft of said speed reduction unit is pierced.

10. The motor drive device according to claim 9,
wherein said speed reduction unit and said shielding member, which covers said speed reduction unit, are attached to a first case; and the first case, to which said control board is attached, is integrated with a second case, whereby said speed reduction unit and said control board are separated in one space.

11. The motor drive device according to claim 9,
wherein said shielding member is a laminated sheet-shaped member, in which a flat cloth sheet is provided on the speed reduction unit side and a plastic sheet is provided on the control board side.

12. The motor drive device according to claim 9,
wherein said motor drive device is used for opening and closing a vehicle sun roof.
